(19) United States
(12) Patent Application Publication
(10) Pub. No.: US 2006/0134449 A1
(43) Pub. Date: Jun. 22, 2006

(54) Weldable metal composites and methods

(76) Inventors: David R. Sigler, Shelby Township, MI (US); Robin Stevenson, Bloomfield, MI (US); Michael J. Karagoulis, Okemos, MI (US)

Correspondence Address: KATHRYN A. MARRA;General Motors Corporation, Mail Code 482-C23-B21, P.O. Box 300, Detroit, MI, 48265-3000, US

(21) Appl. No.: 11/017,410

(22) Filed: Dec. 20, 2004

(51) Int. Cl. B21D 39/00; B32B 15/06

(52) U.S. Cl. 428/621; 428/624; 428/625

(57) ABSTRACT

The present invention is directed to an improved laminated, sound damping resistance weldable composite and a method for its manufacture. The metal composite structure (10) features two metal members (12)(14) sandwiching a viscoelastic layer (26) where the viscoelastic layer entrains electrically conductive particles (28). Barrier elements (32) (34) are disposed between the metal members and the viscoelastic layer to inhibit and/or prevent contaminant migration into the metal from the viscoelastic layer and/or conductive particles during welding.

### I. BACKGROUND OF THE INVENTION

1. Field of the Invention

The present invention relates to metal composites that exhibit sound/vibration damping. More particularly, the present invention relates to laminated metal composites incorporating a barrier layer against migration of alloying elements to improve resistance spot welding.

2. Discussion of the Related Art

Metal composites are used to reduce noise and vibration in a wide range of applications. Such applications include automobiles or other vehicles, machinery, appliances, power equipment and the like. These metal composites typically include a viscoelastic layer disposed between (sandwiched by) two metal sheets. To provide for resistance spot welding, the viscoelastic layer, preferably, incorporates generally uniformly dispersed conductive particles to facilitate electrical conduction between the metal sheets and through the composite during the welding process.

As a result of the sandwiched structure, several undesirable issues arise during resistance spot welding of the metal composites. For example, due to heat generated by current flow through the entrained, conductive particles and heat generated at the weld zone, the conductive particles near the welding electrode melt. Because the viscoelastic layer typically constitutes an organic polymeric composition, during resistive welding, the conductive particles can generate thermal gradients causing discrete evaporation and creation of decomposition residues. When molten, the liquefied conductive particles may 1) admix and alloy directly with the metal of adjacent sandwiching sheets (primary alloys) or 2) first combine with residues/thermal decomposition products of the heated viscoelastic material to then alloy with the metal (secondary alloys). These primary and secondary alloys that form in the proximity of the weld site possess differing melting points, often being lower than the melting point of the adjacent metal sheets. Consequently, during the resistance welding procedure, undesirable, selective localized melting may develop which will reduce weld quality and, through enhanced alloying with, and dissolution of, the bounding metal sheets, metal thickness

At the weld site, the viscoelastic layer around the conductive particles will undergo melting, boiling and localized decomposition producing among other products, carbon. Carbon is a particularly undesirable impurity as it aggressively combines with metals. Ferrous metals, steel and metals susceptible to carbide formation, such as titanium alloys are particularly vulnerable to metallurgical degradation from formation of primary and secondary alloys and/or direct reaction with carbon at the weld site. In addition to the metallurgical degradation adversely impacting weld uniformity, physical degradation is manifested, for example, by local vaporization and the concomitant generation of gas at high internal pressure within the viscoelastic layer in precisely the vicinity of undesirable metallurgical changes. Consequently, blowholes, blisters, and the like may form as a result of such high internal pressures and the local physical stresses they induce.

Testing on low carbon steel composites has shown when the prior art sandwich composites use iron phosphide or nickel conductive particles, upon melting, the liquid readily absorbs carbon from the surrounding decomposed viscoelastic layer where these enriched carbon-containing materials migrate to the adjacent metal sheets. Consequently, the final welded region of a laminate formed from conductive nickel or iron particles will often exhibit localized inconsistencies around a weld site attributable to such undesirable carbon diffusion.

In view of the foregoing problems, it is clear that improvements can be made to the prior art.

### II. SUMMARY OF THE INVENTION

It is therefore an object of the present invention to address and overcome problems of the prior art

Another object of this invention is to provide an improved weldable composite and method.

A further object of the invention is to provide a weldable composite that possesses improved structural integrity and weld uniformity, is relatively light weight, and provides sound/vibration damping.

A final stated, but only one of additional numerous objects of the invention, is to provide a weldable, sound damping composite incorporating a barrier against contaminant migration from either the viscoelastic material or conductive particles into the associated metal structures.

These and other objects are satisfied by a weldable metal composite, comprising, a first metal member and a second metal member; a viscoelastic layer disposed between said first and second metal members, electrically conductive particles dispersed in said viscoelastic layer, and at least a first barrier layer established between a select one of said first metal member or said second metal member and said viscoelastic layer; said at least first barrier layer inhibiting transfer to the metal member of harmful contaminants from the viscoelastic layer or conductive particles during welding of the composite.

The foregoing and other objects are satisfied by a method comprising the steps of making a metal composite by applying a viscoelastic layer between a first metal member and a second metal member where said viscoelastic layer includes electrically conductive particles, establishing a barrier layer between said viscoelastic layer and a select one of said first or second metal members, and resistance welding said first metal member and said second metal member while inhibiting the 1) formation of primary alloys between the conductive particles and metal members, 2) attack of secondary alloys formed by reaction of the molten conductive particles with the high-carbon potential environment, and 3) reaction between the high-carbon potential atmosphere and the metal member itself to pickup carbon and possibly form carbides.

The present invention overcomes the limitations of the prior art by providing an effective barrier to alloy diffusion and/or migration into the metal substrates during the welding process. According to an important aspect of this invention, a barrier layer, the composition of which will depend on the specific composition/metallurgy of 1) the metal substrates, 2) the conductive particles, and 3) the viscoelastic layer, is selected to inhibit diffusion or migration of undesired alloying constituents into the metal substrates. The barrier layer is intended to improve welding uniformity and quality by suppressing weld-induced damage of the metal sheets occasioned by localized development of excess carbides, regions of high hardness, selective local melting, blowholes, blisters, etc.

An aspect of the present invention is directed to a metal composite comprising a metal substrate, commonly in the form of a sheet, having an interior surface and an exterior surface and a metal article having a first surface. The metal elements, e.g., metal substrate and the metal article may be comprised of steel including stainless steel, aluminum alloys, magnesium alloys or titanium alloys. A viscoelastic layer, preferably exhibiting adherent characteristics, and more preferably, exhibiting pressure sensitive adhesion, comprises conductive particles and is disposed between the interior surface of the metal substrate and the first surface of a metal article. Particles of iron, nickel, copper, aluminum, phosphides, carbides, or any electrically conductive alloys and compounds thereof may be employed and dispersed within viscoelastic layer to allow current conduction for resistance welding.

An important aspect of this present invention is the inclusion with the composite laminate of at least a first diffusion barrier layer associated with the interior surface of the aforementioned metal substrate. The barrier may be physically located on the interior surface, preferably as a continuous layer and may be associated with a second barrier layer located on the first surface of the metal article. The barrier layer preferably is formed of copper, nickel, zinc, iron, aluminum or alloys or admixtures thereof. The barrier layer inhibits and/or prevents formation of undesirable alloys, diffusion of carbon, and/or migration of other degenerative products from the viscoelastic layer and/or conductive particles. Accordingly, the desirable metallurgical uniformity and properties of the metal sheet and metal article will be maintained during welding of the composite. Where the metal substrate is in sheet form, it will have a typical total thickness of between about 0.3 mm and about 3.0 mm and will possess sound damping capacity.

Another aspect of the present invention is directed to a method of making a metal composite including the steps of applying an adhesive viscoelastic layer containing electrically conductive particles between an interior surface of a metal sheet and a first surface of a metal article and establishing at least one barrier layer on the interior surface of the metal sheet against carbon diffusion. In a preferred aspect of the invention, a second barrier layer is established on the first surface of the metal article where the first and second barrier layers inhibit and/or prevent carbon diffusion and/or migration of liquefied/gasified organics from the adhesive viscoelastic layer directly into the associated metal substrates or indirectly by first reacting with the molten conductive particles during resistance welding so as to promote metallurgical uniformity at the weld. As a result, damage to the welded metal composite resulting from, for example, non-uniform melting, local thinning, formation of blow holes, cracks or blisters, or the formation of regions of elevated hardness and/or excessive carbide in the metal sheet and article, is inhibited and/or prevented during welding of the composite.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawing, and which is shown by way of illustration to the specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

Given the following detailed description, it should become apparent to the person having ordinary skill in the art that the invention herein provides a lightweight laminated, sound/vibration damping composite and method providing significantly augmented efficiencies while mitigating problems of the prior art.

### III. BRIEF DESCRIPTION OF THE DRAWING

FIG. 1 is a cross-sectional view of a metal composite made in accordance with the present invention.

### IV. DETAILED DESCRIPTION OF THE DRAWING

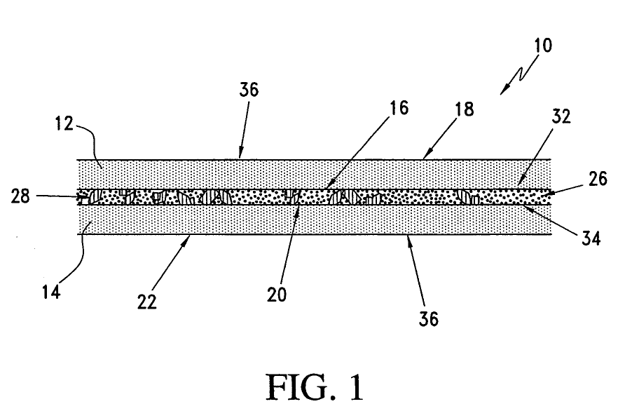

Referring to FIG. 1, it shows a metal composite 10. The metal composite 10 comprises a metal substrate, 12 and a metal article 14 sandwiching a viscoelastic layer 26. The composite 10 of the present invention may be any thickness; however, when in sheet form, as illustrated, the composite is typically between about 0.30 mm and about 3.00 mm total thickness. Preferably, the composite 10 has a total thickness between about 0.6 mm and about 1.5 mm.

The metal substrate is illustrated in generally sheet form, as a sheet 12. Likewise, metal article 14 is illustrated as sheet metal article 14. Notably, metal article may be any shape, including but not limited to a sheet; a longitudinal member including a tube, such as a hydroformed tube or a rail, such as a rail section in an automobile. In the illustrated embodiment, the metal article 14 is a substantially planar sheet member. The substrate 12 includes an interior surface 16 and an exterior surface 18. Similarly, the metal article 14 has a first surface 20 and a second surface 22. The first surface 20 of the metal article 14 may be an interior surface, and the second surface 22 of the metal article may be an exterior surface. The metal sheet 12 and the metal article 14 may be comprised of any metal suitable for welding, including but not limited to steel, aluminum, magnesium, and titanium alloys, etc. Where the metal sheet 12 and/or the metal article 14 are steel, the steel is preferably, but not limited to, low carbon, interstitial free, bake hardenable, high strength low alloy, transformation induced plasticity (TRIP), martensitic, dual phase, galvanized, or stainless steel.

The viscoelastic layer 26 is disposed between the interior surface 16 of the metal sheet 12 and the first surface 20 of the metal article 14 and preferably exhibits sound/vibration damping characteristics. The viscoelastic layer typically has a thickness between about 0.005 mm and about 0.200 mm and, preferably, between about 0.02 mm and about 0.05 mm. The layer 26 may be comprised of any viscoelastic material, but preferably is an adhesive, and more preferably, is a pressure sensitive adhesive effective for bonding the metal substrate 12 to the metal article 14. Such compositions are known to those having skill in the art. For example, layer 26 may be formed of poly(isoprene:styrene), poly (alkyl acrylate), copolymers, terpolymers, etc. thereof. Preferably, the pressure sensitive adhesive of the layer 26 is comprised of a poly(isoprene:styrene) copolymer.

Electrically conductive particles 28 which facilitate welding of the composite 10 are entrained within the layer 26. The conductive particles 28 may be composed of pure metals such as iron, nickel, copper, zinc, aluminum, alloys and compounds thereof such as iron phosphides, electrically conductive organic polymers, etc. Preferably, for steel the conductive particles 28 are comprised of nickel. During welding, the conductive particles 28 melt in the adhesive layer and the adhesive layer 26 decomposes in the region of the weld. These physical changes result in generation of carbon as well as bubbles with high gas pressure that alone or in combination with the molten conductive particles may cause localized damage or dissolution of the metal sheet and metal article as previously described. The particular physical structure of the conductive particles is not believed to be of substantial significance to the invention so long as the conductive particles effectively conduct electric current between the metal members 12 and 14. Preferably, the conductive particles 28, alone, in combination with at least one additional conductive particle, or as agglomerate, extend across the space/gap between the interior surface 16 and the first surface 20.

In FIG. 1, a first barrier 32 is disposed on the interior surface 16 of the sheet-like metal substrate 12 and preferably, but not necessarily, forms a continuous physical layer. A second barrier layer 34 is disposed on the first surface 20 of the metal article 14. The first and second barrier layers 32 and 34 have a thickness from about 0.0005 mm and about 0.02 mm. Preferably, each barrier layer 32 and 34 has a thickness between about 0.002 mm and about 0.010 mm.

The barrier layers 32 and 34 are composed of materials including, but not limited to copper, nickel, zinc, iron, aluminum or alloys or compounds thereof such as iron-zinc compounds. The particulars of the barrier make up will be dictated by the details of the composite and welding techniques. A useful guide for barrier selection can be obtained by examination of the binary phase diagrams for the species of interest and potential barrier materials. Ideally, the composition of each barrier layer 32 and 34 is customized to compliment and correspond to the particular composition of the conductive particles 28, the metal sheet 12 and the metal article 14. As a practical matter, the barrier layer compositions are suggested by binary phase diagrams (see Binary Alloy Phase Diagrams 2^{nd} Edition, T. B. Massalski, 1990, ASM International). Consistent with the objectives of the invention, the selection of the particular composition of the barrier layers 32 and 34 to achieve the intended prophylactic effect against contaminant diffusion and/or migration of harmful contaminants from the layer 26, e.g., carbon, organics, etc., into the adjoining metal members 12 and 14 during welding. For example, for a composite 10 comprising a steel or stainless steel metal substrate 12, metal article 14, and iron alloy conductive particles 28, copper or zinc or copper alloy or zinc alloy barrier layers 32 and 34 are preferred to suppress carbon diffusion. However, when, substrate 12 is aluminum/aluminum alloys with copper conductive particles, barrier layers 32 and 34 preferably comprise thin layers of nickel or nickel alloy. Iron or iron alloy barrier layers 32 and 34 would be preferred for composites 10 comprising a magnesium alloys and copper conductive particles 28. For composites 10 comprising a titanium or titanium alloy metal sheet 12 and metal article 14, wherein carbon alloying would be a concern, a copper barrier layer 32 and 34 to prevent carbon diffusion would be preferred.

The presence of the barrier layers 32 and 34 is of increased importance where the undesirable byproducts (primary alloys, secondary alloys, and high pressure gas) corrupt the integrity of the welded composite, by, for example, locally lowering/decreasing the melting point below that of the original metal sheet or metal article. Consequently, the composition of the barrier layers 32 and 34 should meet at least one of three selection criteria. The first of these criteria is that the barrier layer composition be selected to provide an alloy with a higher melting point rather than a lower melting point than that of the adjoining metal structures. Secondly, the composition or the resulting alloy/species should be immiscible in the barrier layer and, thirdly, if soluble in the barrier layer, then the resulting alloy has a melting point higher than the adjacent metal compositions.

Welding the composite 10 of the present invention may include welding the metal substrate 12 to the metal article 14, or it may include welding the entire composite to another structure or material. The composite 10 of the present invention is suitable for various types of welding including, but not limited to drawn arc welding and resistance welding including resistance spot welding and projection welding. The composite 10 of the present invention is particularly useful for resistance spot welding processes where, during the application of electrical current, the metal substrate 12 and the metal article 14 tend to draw closer together, thus, decreasing the physical space/gap separating interior metal surface 16 and the first surface 20 of the metal article 14.

The composite 10 of the present invention possesses sound/vibration damping characteristics. Thus, it is useful for numerous sound damping applications including, but not limited to use in automobiles or other vehicles, machinery, business equipment, appliances and power equipment. For example, the composite 10 may be used in the plenum, front of dash, or floorpan of an automobile.

The present invention is also directed to a method of making the composite 10 described above. The method includes applying an adhesive layer 26 with conductive particles 28 dispersed therein between the interior surface 16 of a metal sheet 12 and the first surface 20 of a metal article 14. The adhesive layer 26 may be applied by any method known to those having skill in art, including but not limited to extrusion, roll coating or spray coating. The first barrier layer 32 is applied on the interior surface 16 of the metal substrate 12 and a second barrier layer 34 is applied on the first surface 20 of the metal article 14 by any method known to those having skill in the art, including but not limited to electroplating, hot dip coating, roll coating, spray coating, or vapor deposition.

To prevent or inhibit corrosion or rusting of the metal sheet and metal article, the composite 10 may also include a coating 36 located on the exterior surface 18 of the metal sheet 12 and the second surface 22 of the metal article 14. The coating 36 may be comprised of any material known to those having skill in the art which is capable of preventing and/or inhibiting corrosion or rusting of the metal sheet 12 and metal article 14. Preferably, for iron-based metal sheets 12 and 14, the coating 36 is a galvanized coating.

Specific composites and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

What is claimed is:

1. A weldable metal composite, comprising:
a first metal member and a second metal member;
a viscoelastic layer disposed between said first and second metal members;
electrically conductive particles dispersed in said viscoelastic layer;
at least a first barrier layer located between a select one of said first metal member or said second metal member and said viscoelastic layer; said at least first barrier layer inhibiting transfer to the metal member of harmful contaminants from the viscoelastic layer during welding of the composite.

2. The metal composite according to claim 1 where said at least first barrier layer is composed from a material optimized by reference to binary phase diagrams.

3. The metal composite according to claim 2 where the barrier material is selected from the group consisting of copper, nickel, zinc, iron, aluminum, admixtures thereof and alloys thereof.

4. The metal composite according to claim 2 where the said at least first barrier layer is formed between said viscoelastic layer and said first metal member and said metal composite further comprising a second barrier layer disposed between said viscoelastic layer and said second metal member.

5. The metal composite according to claim 1 where said viscoelastic layer is a pressure sensitive adhesive.

6. The metal composite according to claim 5 where said pressure sensitive adhesive is selected from the group consisting of poly(isoprene:styrene), copolymers, terpolymers, thereof, and poly (alkyl acrylate), copolymers, terpolymers, etc.

7. The metal composite according to claim 1 where said at least one barrier layer is continuous and has a thickness of about 0.0005 mm to about 0.02 mm.

8. The metal composite according to claim 7 where said at least first barrier layer has a thickness between about 0.002 mm and about 0.010 mm.

9. The metal composite according to claim 1 where said conductive particles are composed of a material selected from the group consisting of iron, nickel, copper, aluminum, and or electrically conductive alloys and compounds thereof.

10. The metal composite according to claim 1, wherein said first metal member and said second metal member are composed of a material selected from the group consisting of steel, aluminum alloy, magnesium alloy and titanium alloy.

11. The metal composite according to claim 10, wherein at least one of said first and second metal members is composed of steel characterized by properties selected from the group consisting of low carbon, interstitial free, bake hardenable, high strength, low alloy, transformation induced plasticity, martensite, dual phase, and galvanized steel.

12. The metal composite according to claim 3, wherein the first and second metal members are substantially sheet-like and the composite is between about 0.30 mm and about 3.00 mm total thickness.

13. The metal composite of claim 12, wherein the composite is between about 0.60 mm and about 1.50 mm total thickness.

14. A sound damping composite structure comprising:
a first steel sheet having an interior surface and an exterior surface;
a second steel sheet having an interior surface and an exterior surface;
an adhesive layer located between the interior surface of the first steel sheet and the interior surface of the second steel sheet, the adhesive layer comprising conductive particles which allow electric current to flow between the first and second steel sheets during welding of the composite;
a first barrier layer located on the interior surface of the first steel sheet; and
a second barrier layer located on the interior surface of the second steel sheet;
the first and second barrier layers able to inhibit diffusion of carbon from the adhesive layer into the steel sheets during welding of the composite.

15. The metal composite of claim 14, wherein the composite has a thickness of between about 0.30 mm and about 3.00 mm and is resistance spot weldable.

16. The metal composite according to claim 14 where each of said first and second barrier layers is formed from a material selected from the group consisting of copper, nickel, zinc, iron, aluminum, admixtures thereof and alloys thereof.

17. The metal composite according to claim 16 where said adhesive is pressure sensitive and selected from the group consisting of poly(isoprene:styrene), copolymers, terpolymers, thereof, and poly (alkyl acrylate), copolymers, terpolymers, etc.

18. A method of making a metal composite comprising the steps of:
applying a viscoelastic layer between a first metal member and a second metal member where said viscoelasatic layer includes electrically conductive particles;
establishing a barrier layer between said viscoelasatic layer and a select one of said first or second metal members;
resistance welding said first metal member and said second metal member together, and inhibiting the formation of primary and secondary alloys by preventing migration of carbon through said barrier layer.

19. The method according to of claim 18, where said barrier layer is applied by a select one of extrusion, roll coating and spray coating where the barrier layer is disposed between said viscoelastic layer and said first metal member, further comprising the step of applying a second barrier layer between said viscoelastic layer and said second metal member.

20. The method according to of claim 19 further providing sound/vibration damping characteristics to the welded composite and maintaining the total thickness of the composite between about 0.3 mm and about 3.0 mm.
